(19) United States
(12) Patent Application Publication
(10) Pub. No.: US 2008/0115904 A1
(43) Pub. Date: May 22, 2008

(54) Combination metal and epoxy mold

(75) Inventor: Edmund Aversenti, Oldwick, NJ (US)

Correspondence Address: LERNER, DAVID, LITTENBERG,;KRUMHOLZ & MENTLIK, 600 SOUTH AVENUE WEST, WESTFIELD, NJ, 07090, US

(73) Assignee: GMIC, Corp., Linden, NJ (US)

(21) Appl. No.: 11/600,677

(22) Filed: Nov. 16, 2006

(51) Int. Cl. B22D 23/00; B29C 33/38; B29C 33/56

(52) U.S. Cl. 164/46; 264/219; 249/114.1

(57) ABSTRACT

A lightweight mold structure is disclosed, which includes a metal layer and a polymer filled with metal support. The support provides strength to the mold, without the added weight of a solid metal structure. The metal utilized in the polymer is preferably a plurality of metal spheres. Methods of forming the lightweight mold are also disclosed.

### BACKGROUND OF THE INVENTION

Industrial processes such as molding and layup of composite materials, thermoforming, injection molding and reaction injection molding require tools having shapes specific to the article to be made. For example, a composite article can be formed in a mold having an internal shape corresponding to the shape of the desired article by laying up fibers and a matrix composition such as an epoxy or other polymeric material on the surface of the mold and curing the polymer composition. In some cases, the fibers and composition are held between two mating mold parts so that the fibers and composition are squeezed between the surfaces of the mold parts. In reaction injection molding, two or more mating mold parts are brought together to form a substantially closed cavity and a reactive polymer composition is placed within the cavity and cured to form a shape corresponding to the shape of the cavity.

There has been an ever-increasing need for large molds in numerous industries. For example, in the aerospace industry, the increasing prevalence of composite structural materials in airframes has lead to a substantial need for practical large molds. These molds often must meet demanding conditions in use. For example, composite parts used in airframes must meet exacting standards for fit and finish and often incorporate complex curved surfaces. Also, many useful materials such as carbon-fiber reinforced graphite composites (“CFRP”) must be molded at relatively high temperatures. Molds formed from alloys having low coefficients of thermal expansion such as nickel alloys are preferred for bonding these materials.

Thus, the importance of these molds is evident. However, the process of creating such molds has been somewhat difficult. While tools for fabrication of small parts are often machined from solid metals, using conventional machining techniques, these techniques are impractical in the case of very large molds, having dimensions of a meter or more. The cost of machining these large molds from solid blocks of material is prohibitive. However, there have been several innovative and cost effective methods for fabricating such molds proposed.

As described in greater detail in commonly assigned U.S. Pat. No. 5,817,267 (“the '267 patent”) and U.S. Pat. No. 6,447,704 (“the '704 patent”), the disclosures of which are hereby incorporated by reference herein, molds and other tools of essentially unlimited dimensions may be formed from a wide variety of metals, including low-expansion nickel and iron alloys, by a thermal spraying process. As described in certain embodiments of the '267 patent, a shell having a working surface with a desired shape can be formed by providing a matrix having the desired shape and spraying droplets of molten metal using a thermal spray gun, such as a plasma spray gun or arc spray gun onto the matrix. Such spraying can be used to build up the metal to a substantial thickness, typically about one-quarter inch (6 mm) or more. During the deposition process, the spray gun is moved relative to the matrix so that the spray gun passes back and forth over the surface of the matrix in a movement direction and so that the spray gun shifts in a step direction transverse to the movement direction between passes. Thus, during at least some successive passes, metal is deposited on the same region of the matrix from two different spray directions in a “crisscross” pattern. The resulting shells have substantial strength and good conformity with the matrix to provide a faithful reproduction of the matrix shape. Although the '267 patent is not limited by any theory of operation, it is believed that deposition of the metal in different spray directions can produce an interwoven pattern of metal droplets and/or metal grains in the deposited shell, and that this produces a stronger, generally better shell.

While the fabrication of large molds, as taught in the '267 and '704 patents, is indeed innovative and cost effective, there are drawbacks. Although the process as taught in the '267 and '704 patents utilizes less material than the average mold, molds of the type disclosed therein are often large and thus, very heavy. The shear size and weight of these molds often creates logistical problems relating to the transportation or other movement of the molds.

Therefore, there exists a need for a lighter weight mold for use in large scale industrial molding processes.

### SUMMARY OF THE INVENTION

A first aspect of the present invention is a method of making a mold. In accordance with one embodiment of this first aspect, the method includes the steps of providing a matrix having an active surface corresponding to a shape to be molded, forming a first metal layer on the active surface of the matrix, the first metal layer including a working surface corresponding to the active surface and an outer surface, molding a mixture including a curable liquid material and a plurality of metallic spheres on the outer surface, to form a support, and removing the matrix.

A second aspect of the present invention is a mold. In accordance with one embodiment of this second aspect, the mold includes a unitary metallic structure having a working surface having a shape corresponding to the shape of an article to be molded and an outer surface and a support attached to the outer surface of the structure. The support preferably includes a curable liquid material and a plurality of metallic spheres.

A third aspect of the present invention is another method of making a mold. In accordance with one embodiment of this third aspect, the method includes the steps of providing a matrix having an active surface corresponding to a shape to be molded, spray depositing a first metal layer on the active surface of the matrix, the first metal layer including a working surface corresponding to the active surface and an outer surface, spraying a metal into a container of liquid to form a plurality of metallic spheres, drying the plurality of metallic spheres, mixing the plurality of metallic spheres with a curable liquid material to form a mixture, molding the mixture on the outer surface to form a support, and removing the matrix.

A fourth aspect of the present invention is a method of forming hollow or porous metal structures. In accordance with one embodiment of this fourth aspect, the method includes the steps of spraying metal into a container of liquid to form the structures and drying the structures under heat. The method may also include spraying metal from a spray gun situated ten to twelve inches from a container of water and/or mixing the plurality of metal spheres with a curable liquid to form a mixture.

### BRIEF DESCRIPTION OF THE DRAWINGS

A more complete appreciation of the subject matter of the present invention and the various advantages thereof can be realized by reference to the following detailed description in which reference is made to the accompanying drawings in which:

FIG. 1 is a cross sectional view depicting formation of a metallic first layer on a matrix.

FIG. 2 is a cross sectional side view of a fully formed first layer removed from the matrix.

FIG. 3 is a cross sectional side view of a fully constructed mold in accordance with one embodiment of the present invention.

FIG. 4 is an enlarged view of a metallic sphere in accordance with the present invention.

FIG. 5 is a cross sectional side view of a fully formed first layer removed from the matrix, in accordance with another embodiment of the present invention.

FIG. 6 is a cross sectional side view of a fully constructed mold in accordance with another embodiment of the present invention.

FIG. 7 is a cross sectional side view of a fully formed first layer removed from the matrix, the first layer having a plurality of conformal lines laid upon it.

FIG. 8 is a cross sectional side view of a fully constructed mold including conformal lines.

### DETAILED DESCRIPTION

In describing the preferred embodiments of the subject matter illustrated and to be described with respect to the drawings, specific terminology will be used for the sake of clarity. However, the invention is not intended to be limited to any specific terms used herein, and it is to be understood that each specific term includes all technical equivalents which operate in a similar manner to accomplish a similar purpose.

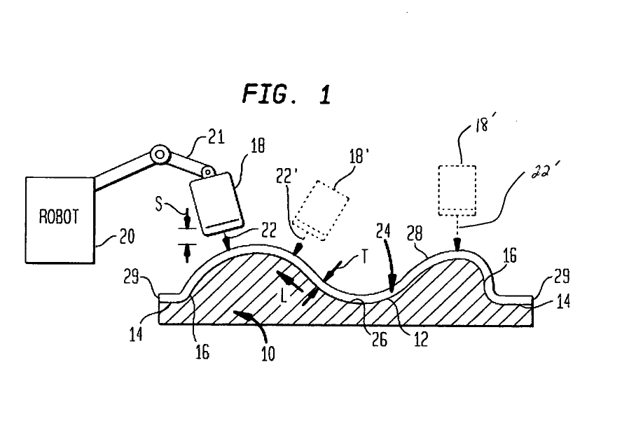

A process for making a mold or shell 1 in accordance with one embodiment of the present invention first includes steps which utilize a master model or matrix 10 (shown in FIG. 1) having an active surface 12 with a shape corresponding to the shape of the part to be molded. As described in greater detail in the '267 patent, the matrix desirably also includes edge regions 14 projecting outwardly from active surface 12 and a side wall 16 extending between the edge regions and active surface 12. Matrix 10 can be formed from essentially any material having useful structural strength at the temperatures attained by the matrix during application of the sprayed metal, typically on the order of 220° F. (104° C.). Similarly, matrix 10 can be formed by any conventional process. For example, high-temperature epoxy composite tooling compounds can be cast to its shape using a master tool (not shown). Readily machinable materials such as polymeric materials, metals such as aluminum or brass and graphite may be machined to shape using conventional methods such as numerically controlled machining methods to form the matrix. Although matrix 10 is depicted as a solid, unitary body, it may incorporate internal structures such as hollow spaces, reinforcing members such as metal bars or fibers and the like. Also, the matrix typically is supported on a supporting structure such as a table or machine bed (not shown).

As is shown in FIG. 1, a thermal spray gun 18 linked to a conventional industrial robot 20 is used to spray deposit molten metal onto matrix 10. Thermal spray gun 18 may be a conventional plasma spray gun or an arc spray gun. For example, a typical spray gun such as that sold under the designation Model BP400 Arc Spray System by Miller Thermal, Inc. of Appleton, Wis. is arranged to apply an electrical potential to strike an arc between a pair of wires and to feed the wires continually into the arc while blowing a stream of a compressed gas through the arc. The stream carries a spray of metal droplets formed from the molten wire at a high velocity in a relatively narrow pattern extending from the front of the gun so that the droplets move principally in a spray direction 22. During a spraying process, the sprayed metal droplets impinge on active surface 12 of matrix 10 and deposit as a first layer 24 having a working surface 26 conforming to the shape of active surface 12, wall 16, and edge regions 14 of the matrix. In addition, first layer 24 not only includes working surface 26, which conforms to the shape of active surface 12 and the shape of the part to be molded, but also an opposite outer surface 28 and edges 29. First layer 24 preferably has a thickness T between working surface 26 and outer surface 28, which extends in a direction generally normal to the working surface 26 and hence normal to active surface 12 of matrix 10. In one preferred embodiment, thickness T is generally between one sixteenth (0.0625) and one eighth (0.125) of an inch. The layer also has lateral directions L transverse to working surface 26. Thus, the lateral directions of layer 24 are the directions generally to the left and right and generally into and out of the plane of the drawing shown in FIG. 1.

A non-oxidizing gas such as nitrogen may be used as the gas in spraying and may be applied as a gas blanket over the area being sprayed. The use of such a non-oxidizing blanket minimizes oxidation of the metal during the process and promotes bonding of newly-sprayed metal to previously-sprayed metal. Additionally or alternatively, a nitrogen blanket could encapsulate the stream of molten metal or metal droplets during operation. This aids in preventing the metal particles of the stream from picking up oxygen during their molten state.

During the spraying steps, robot 20 preferably maintains spray gun 18 at a pre-selected standoff distance or spacing S from the matrix and from the deposited layer. The standoff distance will depend upon the spray conditions and the particular head employed, but most typically, in accordance with the present invention, is about 6-10 inches. As the metal is sprayed from spray gun 18, robot 20 moves the spray gun head in a sweeping pattern over active surface 12 and the adjacent walls and edge regions of the matrix. Desirably, the robot moves spray gun 18 in a movement direction as, for example, into and out of the plane of the drawing as seen in FIG. 1 and shifts the head in a step direction transverse to the movement direction (to the left and right in FIG. 1) between passes. The robot generally situates spray gun 18 so that spray direction 22 is at a ninety (90) degree angle with respect to active surface 12 of matrix 10 (further positions of the gun are shown in the depiction of spray gun 18′ having spray directions 22′ in FIG. 1). The “splat” or pattern of metal droplets hitting working surface 26 is assured substantially equal distribution when the spray direction 22 is situated at this ninety (90) degree orientation with respect to active surface 12, something that is clearly desired in order to create a uniform first layer 24.

However, it is to be understood that spray gun 18 may be situated so that spray direction 22 is at various angles, in certain situations, in order to more uniformly spray the metallic droplets. For example, active surfaces 12 that include severe or deep undulations may require an angled spray direction 22 to properly coat the surface with metal. The process of spraying the first layer 24 is continued until a desired thickness is achieved. For example, as is mentioned above, in certain preferred embodiments, spray gun passes are made until thickness T is approximately between 0.0625 and 0.125 inches at every point over the entire area of first layer 24.

The material used to form first or first layer 24 is selected for compatibility with the material ultimately to be molded, as well as the other elements of mold 1 of the present invention. The latter situation will be discussed more fully below. Particularly in those applications involving elevated temperatures or substantial temperature changes during the molding operation, the material used to form the first layer is selected to have a low coefficient of thermal expansion and to provide substantial strength at elevated temperature. Merely by way of example, materials such as aluminum alloys, ferrous metals such as stainless steels and iron-nickel alloys can be used. Alloys formed predominantly from iron and nickel are particularly preferred for this purpose. As used in this disclosure, a metal formed “predominantly from” certain metals contain at least about 50% of those metals in the aggregate. Thus, a metal formed predominantly from iron and nickel contains at least about 50% iron and nickel in the aggregate and 50% or less of other materials by weight. Alloys of iron and nickel containing between about 30% and about 55% nickel and between about 45% and about 70% iron are particularly preferred. The most preferred low-expansion alloys are those containing about 36% nickel, such as those sold under the commercial designation INVAR®.

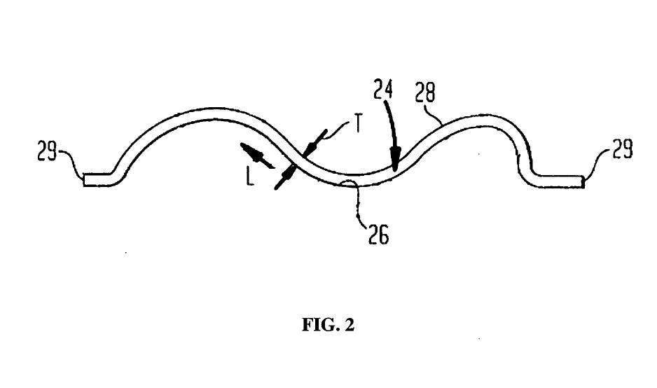

Once a suitable thickness T first layer 24 is created, the remainder of mold 1 may be constructed. This may be accomplished with or without the removal of master model or matrix 10. In other words, first layer 24 may or may not be separated from matrix 10 during the below discussed further steps. In the case of separation, removal of first layer 24 from matrix 10 may require the cooling or curing of first layer 24 prior to its separation with matrix 10. As is described in greater detail in the '267 patent, the layer can be allowed to cool gradually, desirably over a period of several hours and preferably over a longer time before being removed from matrix 10. For example, very large molds may be cooled from about 150° C. to about 20° C. over a period of several weeks in a temperature controlled environment with subsequent cooling at normal room temperature. It is believed that such gradual cooling tends to stabilize the layer and prevent warpage when first layer 24 is ultimately removed from matrix 10. As also described in the '267 patent, those portions of first layer 24 extending along side walls 16 of matrix 10 may form ribs projecting from the remainder of the shell which further tend to stiffen the shell and reinforce it against warpage. Those ribs may remain in place in the finished mold or else may be removed after cooling. A removed first layer 24 is shown in FIG. 2.

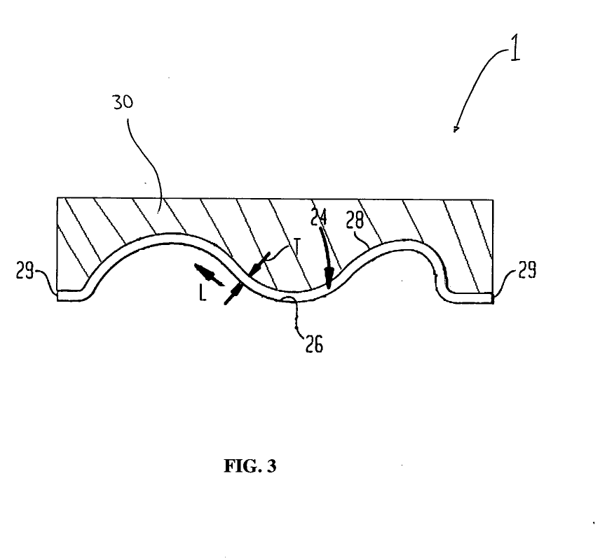

Onto outer surface 28 (either before or after removal from matrix 10) a metal filled polymer, such as an epoxy or urethane, support 30 is preferably molded. It is noted that although referred to throughout as a polymer material, support 30 may be formed of any suitable curable liquid material capable of being mixed with a metal, molded onto surface 28, and then cured. A mold 1 having support 30 already molded onto first layer 24 is shown in FIG. 3. The function of this structure is to add stability to the relatively thin, but often times, rather large first layer 24. However, support 30 preferably does this without adding significant weight to mold 1 as a whole. Rather than add more metallic material to, for example, increase the overall thickness of first layer 24, support 30 is molded onto surface 28 of first layer 24, thereby keeping the overall weight of mold 1 low. Although support 30 includes metal within its polymer material, such metal is constructed to be strong, yet lighter than solid metal. The particular metal structure utilized will now be discussed.

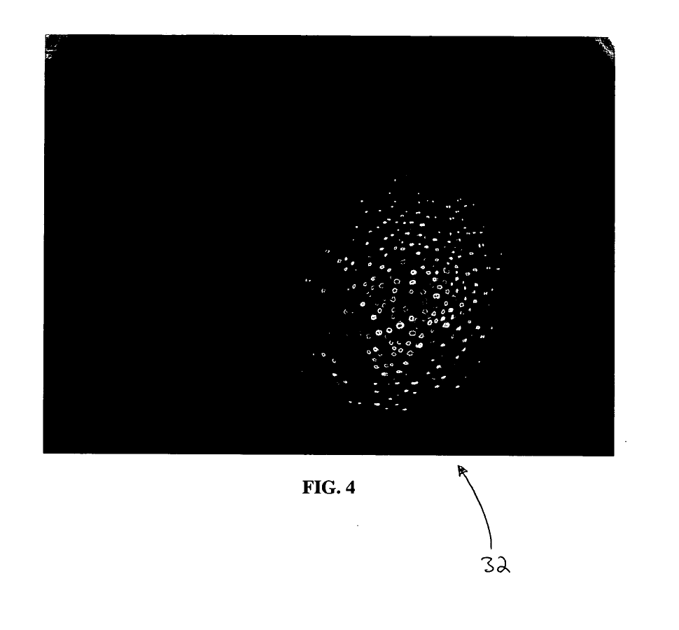

In one embodiment, the metal utilized in support 30 is a plurality of spheres 32 of metal. An enlarged view of one such sphere 32 is shown in FIG. 4. However, it is to be understood that any type of metallic structure may be utilized in accordance with the present invention. The creation of spheres 32 preferably utilizes a similar spray gun to that of above-described spray gun 18. The gun is utilized to spray a stream of molten metallic material into a structure filled with a liquid such as water. In one preferred embodiment, spray gun 18 is used to spray a stream of INVAR® material into a 55 gallon drum half filled with water. The gun is held approximately ten (10) to twelve (12) inches above the drum during spraying of the INVAR® material. The high velocity spraying of molten metal into the water causes the creation of a plurality of hollow or porous spheres 32, which preferably settle to the bottom of the drum. Even though spheres 32 are hollow or porous, their density is still greater than the water. After a period of cooling, spheres 32 are collected and dried in an oven for several hours at a temperature of approximately 300° F. It is to be understood that spheres 32 may not be perfectly round, and may exhibit other shapes. In addition, spheres 32 may be any size, which may or may not be dictated by the process utilized in forming same. Spheres 32 may include one or more hollow portions, either on their interior or extending to their exterior. It is to be understood that while one embodiment sphere 32 in accordance with the present invention is shown, many different types can be created utilizing similar creation methods to those discussed above.

Support 30 is preferably constructed of any suitable polymer, such as an epoxy or urethane, with a plurality of spheres 32 disposed therein. The metal of spheres 32 is also similar, if not identical, to that utilized in forming first layer 24. This provides a support 30 to cooperate with first layer 24, which has a similar or identical coefficient of thermal expansion (“CTE”). This similar CTE ensures that support 30, when subjected to heat during a molding process, will expand or contract at about the same rate as first layer 24. For example, in a preferred embodiment, first layer 24 is constructed of INVAR®, spheres 32 are constructed of INVAR®, and the polymer material is an Epocast-type epoxy sold by Shell Chemical. As is noted above, the inclusion of metal spheres 32 within the polymer structure preferably provides for a stronger support 30 resulting in a stronger mold.

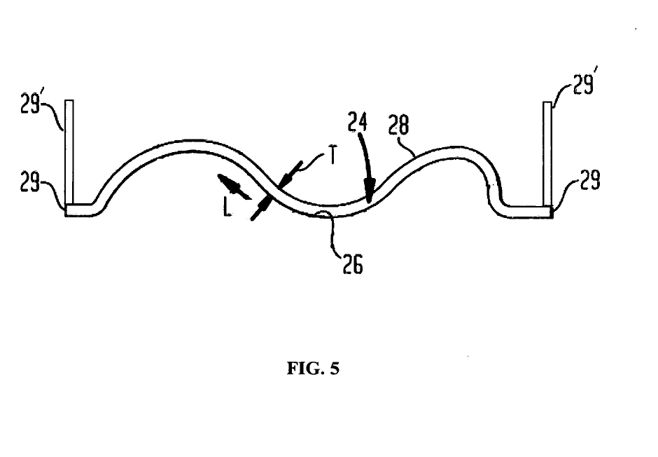

Many suitable processes may be utilized in forming support 30 and molding same onto outer surface 28 of first layer 24. For example, it is contemplated to drop or otherwise introduce the plurality of spheres 32 into liquid epoxy. Thereafter, such composition may be mixed to ensure a uniform composition of metal and polymer throughout support 30. This metal and polymer mixture may then be molded onto outer surface 28 of first layer 24, as is shown in FIG. 2. Once again, any suitable molding method may be utilized in performing this step. Molding of polymer materials, such as epoxies or urethanes, is well-known in the art, and any known or heretofore developed method may be employed in accordance with the present invention. For example, in addition to utilizing removable molding components to retain the liquid epoxy and metal sphere 32 structure, it is to be understood that first layer 24 may be provided with an extension 29′ that extends along the perimeter of first layer 24 at or near edges 29 (shown in FIG. 5). This extension 29′ may be similarly formed during the above-described spraying of first layer 24, or could be added as separately created elements to the layer.

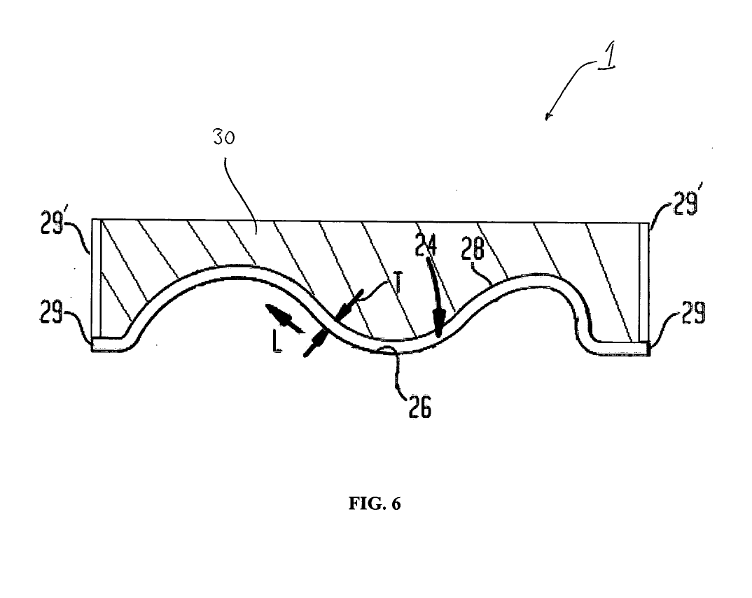

As is shown in the cross-sectional view of FIG. 2, extension 29′ preferably forms an enclosed box-like structure that can easily accept the liquid polymer and metal sphere 32 mixture and retain same during a curing process. In other words, first layer 24 with extension 29′ acts as an enclosed mold structure similar to those utilized in the art. The polymer mixture may be poured into this enclosure and allowed to cure, thereby forming support 30 attached to first layer 24 (shown in FIG. 6). Of course, extension 29′ may be any size, and may or may not be designed so as to be removed subsequent to the curing of support 30. In addition, any means may be employed to perform the molding of support 30. For example, the liquid polymer and metal mixture may be injected into the enclosed mold formed by first layer 24 and extension 29′. Such injection processes are well-known in to those of ordinary skill in the art. The amount of time required for the polymer and metal mixture to cure depends upon the particular materials utilized. Certain polymers take longer than others to cure, and some may require the application of heating or cooling. Furthermore, the ratio of metal to polymer may vary the curing time. In certain cases, the lesser the overall amount of polymer in relation to metal, the shorter the curing period. In any event, once cured, a mold 1, as shown in FIGS. 3 and 6, is provided.

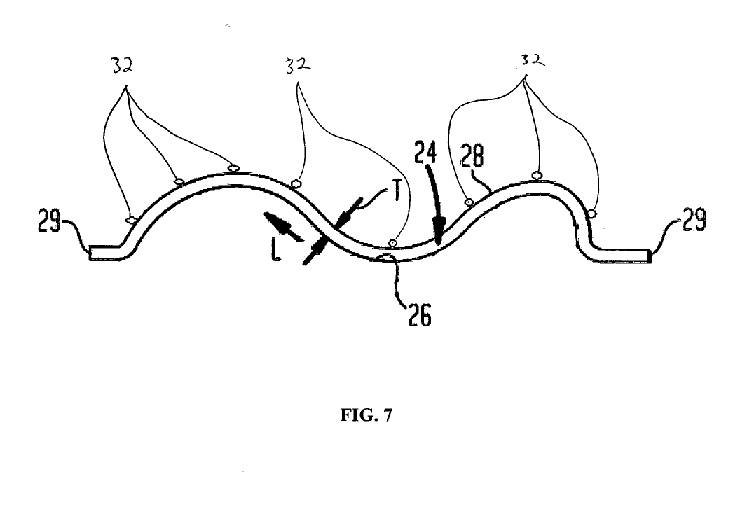

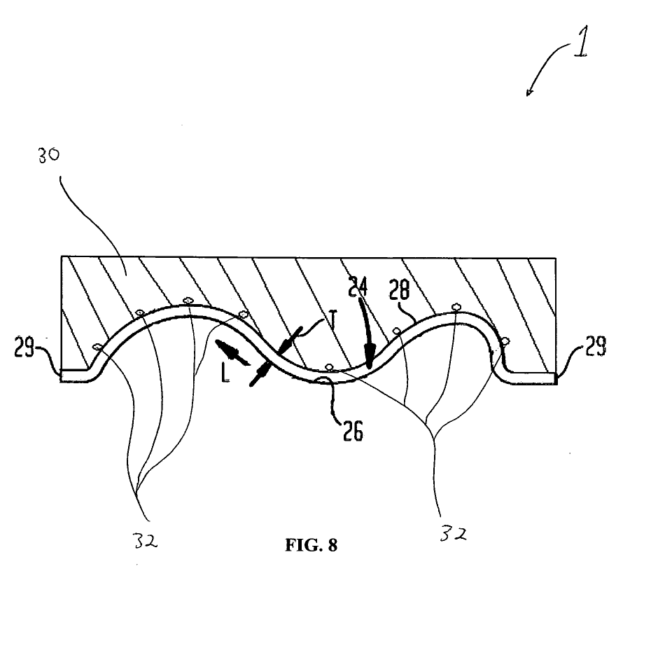

It is also to be understood that conformal lines 34 may be provided during the step of molding support 30 to first layer 24. Conformal lines 34 are essentially elongate, tubular members which are laid upon surface 28 prior to molding support 30 thereto. This is depicted in FIG. 7. Subsequent to molding support 30 onto surface 28, conformal lines 34 provide passages for the introduction of cooling and or heating liquids. These cooling or heating materials provide like cooling or heating to a material being molded on surface 26 through heat transfer during a molding process utilizing mold 1. For example, for cooling cold water or Freon may be introduced through conformal lines 34, and such may aid in faster curing of material being molded. Likewise, steam or hot oil may be introduced through conformal lines 34, and such may aid in the molding and curing process. The material forming conformal lines 34 preferably is capable of receiving a flow of any of these heating or cooling liquids, or the like. FIG. 8 depicts a fully constructed mold 1 having conformal lines 34 extending therethrough.

Ultimately, mold 1 has a working surface 26 corresponding to the interior surface of first layer 24 and conforming to the shape of matrix 10. The completed mold can be used as a mold or a mold component. For example, in reaction injection molding or blow molding, two such assemblies can be engaged with one another so that their respective first layers 24 form a closed cavity and a molten composition can be squeezed between the molds. In other processes such as thermoforming and some lay up processes, only one mold 1 may be employed.

As described in the '267 patent, working surface 26 can be polished or otherwise treated to provide the desired surface finish. Also, the metal layers formed by thermal spraying may be porous or may be dense and substantially non-porous, depending upon the spray deposition conditions. The working surfaces of the mold may be impregnated with a polymer or with a metal such as nickel by electroplating or electroless plating. Polymeric coatings such as homopolymers and copolymers of tetrachlorethylene, flouranated ethylene propylene, perofluoro alkoxyethylene, acrylics, vinylidene fluorides and amides can be applied by conventional coating and impregnation techniques to enhance the release properties of the mold and to decrease its porosity. Surface treatments such as those sold under the registered trademarks TUFRAM and NEDOX, release agents such as those sold under the registered trademark PLASMADIZE and coatings such as those sold under the registered trademark LECTROFLUOR, all available from the General Magnaplate Corporation of Linden, N.J. may be applied on the working surfaces of the shells.

Finally, numerous variations and combinations of the features discussed above can be employed without departing from the present invention. It is contemplated that the above discussed steps for forming first layer 24 can be modified in accordance with certain embodiments of the present invention. For example, first layer 24 may be created in accordance with the process disclosed in commonly owned U.S. patent application Ser. No. 11/003,715, the disclosure of which is hereby incorporated by reference herein. Essentially, the process taught therein would result in a first layer 24 which includes a fiber structure encapsulated by one or more metallic layers. Also, it is not essential to form every metal layer by spray deposition in accordance with the present invention. For example, first layer 24 can be formed in part or in whole by other processes, such as by plating and the remaining thickness of the layer can be formed by the steps as discussed above.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A method of making a mold comprising the steps of:
(a) providing a matrix having an active surface corresponding to a shape to be molded;
(b) forming a first metal layer on the active surface of the matrix, the first metal layer including a working surface corresponding to the active surface and an outer surface;
(c) molding a curable liquid material and a plurality of metallic spheres mixture on the outer surface, to form a support; and
(d) removing the matrix.

2. The method of claim 1, wherein the forming step includes spray depositing the first metal layer on the active surface of the matrix.

3. The method of claim 2, wherein the spray depositing step includes making a plurality of passes with a spray gun in a plurality of directions relative to the active surface.

4. The method of claim 3, wherein the spray gun is oriented in a plurality of orientations relative to the active surface.

5. The method of claim 2, wherein the spray depositing step includes spray depositing a material including approximately 30-42% nickel.

6. The method of claim 5, wherein the first layer is between 0.0625 and 0.125 inches thick.

7. The method of claim 6, wherein the first layer has an exterior surface area of at least one square meter.

8. The method of claim 1, further comprising the step of mixing the plurality of metal spheres with a liquid polymer to form the mixture.

9. The method of claim 8, wherein the plurality of metal spheres are formed by spraying metal into a container of liquid.

10. The method of claim 9, wherein the plurality of metal spheres are removed from the liquid and dried under heat.

11. The method of claim 10, wherein the plurality of metal spheres are formed of a material including approximately 30-42% nickel.

12. The method of claim 1, wherein the metallic material of the first layer and the plurality of metal spheres include similar coefficients of thermal expansion.

13. The method of claim 12, wherein the first layer and the plurality of metal spheres are formed of a material including approximately 30-42% nickel.

14. The method of claim 1, further comprising the step of providing conformal lines in the mold.

15. The method of claim 1, wherein the removing step is performed before the molding step.

16. A mold comprising:
a unitary metallic structure having a working surface having a shape corresponding to the shape of an article to be molded and an outer surface;
and a support attached to the outer surface of the structure, the support including a curable liquid material and a plurality of metallic spheres.

17. The mold of claim 16, wherein the working surface is at least one square meter in area.

18. The mold of claim 16, further comprising a plurality of conformal lines.

19. The mold of claim 16, wherein the structure and the spheres are formed of a material including approximately 30-42% nickel.

20. A method of making a mold comprising the steps of:
(a) providing a matrix having an active surface corresponding to a shape to be molded;
(b) spray depositing a first metal layer on the active surface of the matrix, the first metal layer including a working surface corresponding to the active surface and an outer surface;
(c) spraying a metal into a container of liquid to form a plurality of metallic spheres;
(d) drying the plurality of metallic spheres;
(e) mixing the plurality of metallic spheres with a curable liquid material to form a mixture;
(f) molding the mixture on the outer surface to form a support; and
(d) removing the matrix.

21. A method of forming hollow or porous metal structures comprising the steps of:
spraying metal into a container of liquid to form the structures; and
drying the structures under heat.

22. The method of claim 21, wherein the plurality of metal spheres are formed of a material including approximately 30-42% nickel.

23. The method of claim 22, wherein the liquid is water.

24. The method of claim 23, wherein the spraying step includes spraying metal from a spray gun situated ten to twelve inches from the water.

25. The method of claim 24, furthering comprising the step of mixing the plurality of metal spheres with a curable liquid to form a mixture.
